(19) United States
(12) Patent Application Publication
(10) Pub. No.: US 2025/0174718 A1
(43) Pub. Date: May 29, 2025

(54) GEL ELECTROLYTE COMPOSITION AND SECONDARY BATTERY INCLUDING THE SAME

(71) Applicants: KOREA RESEARCH INSTITUTE OF CHEMICAL TECHNOLOGY, Daejeon (KR); UNIST (ULSAN NATIONAL INSTITUTE OF SCIENCE AND TECHNOLOGY), Ulsan (KR)

(72) Inventors: Seo Hyun JUNG, Daejeon (KR); Mid Eum KIM, Daejeon (KR); Hyun-Kon SONG, Ulsan (KR); Jihong JEONG, Ulsan (KR)

(73) Assignees: KOREA RESEARCH INSTITUTE OF CHEMICAL TECHNOLOGY, Daejeon (KR); UNIST (ULSAN NATIONAL INSTITUTE OF SCIENCE AND TECHNOLOGY), Ulsa (KR)

(21) Appl. No.: 18/725,601

(22) PCT Filed: Dec. 7, 2022
(86) PCT No.: PCT/KR2022/019815

§ 371 Date: Jun. 28, 2024

(30) Foreign Application Priority Data
Dec. 30, 2021 (KR) 10-2021-0192829
Oct. 4, 2022 (KR) 10-2022-0126618

(51) Int. Cl. H01M 10/0565; H01M 10/052

(52) U.S. Cl. CPC H01M 10/0565; H01M 10/052; H01M 2300/0082

(57) ABSTRACT

The present disclosure relates to a gel electrolyte composition including a fluorine-containing copolymer including repeating units represented by following Formula 1 and following Formula 2, lithium salt, and an organic solvent, and a secondary battery including the same.

### TECHNICAL FIELD

The present disclosure relates to a flame retardant gel electrolyte composition and a secondary battery including the same.

### BACKGROUND ART

A secondary battery, which refers to a battery to consecutively charge and output electrical energy, has conventionally been used as a driving power source or a backup power source for a cellular phone, a laptop computer, or a smaller-sized portable device.

Recently, global warming resulting from greenhouse gas has attracted attention worldwide. To solve this problem, the secondary battery is expected to be increasingly used partially or entirely in various fields, such as a vehicle, a ship, aviation, and heating, using fossil fuels.

As described above, the secondary battery needs to have a higher power characteristic, such as a lager capacity or higher-speed charging, and to further have excellent stability and durability, such that the secondary battery is utilized as an alternative energy source in various fields. However, a conventional secondary battery has faced technical trade-off relationship to make the difficulty in improving both the higher power characteristic and the stability.

In particular, the explosion and the combustion of the conventional secondary battery may be made due to various causes such as thermal runaway resulting from high energy released for a short period of time due to a short circuit between a positive electrode and a negative electrode or due to the rise of a voltage resulting from the increase of a side reaction between a positive electrode active material and a gel electrolyte as the secondary battery is overcharged.

Meanwhile, the deterioration of the secondary battery is related to the lifespan of the secondary battery. Specifically, as the temperature of the secondary battery increases, the side reaction may increase, thereby causing a decrease in the charge/discharge capacity of the secondary battery.

To solve such a stability issue of the secondary battery, studies and researches have been conducted on a gel-polymer electrolyte, which is prepared by putting a plasticizer in a polymer matrix, instead of a liquid electrolyte having lower thermal stability and the risk of electrolyte leakage. The gel-polymer electrolyte is an intermediate electrolyte which may improve both the lower stability of the liquid electrolyte and the lower ion conductivity of a solid-polymer electrolyte by using the principle that lithium ions rapidly move through pores formed along polymer fiber entangled in a gel form.

However, the gel-polymer electrolyte remarkably reduced in explosion and combustion while exhibiting excellent performance has been not sufficiently developed. The short circuit between the positive electrode and the negative electrode, which is the biggest cause of the stability issue of the secondary battery, is failed to be fundamentally solved. In addition, the gel-polymer electrolyte has an inferior adhesion property to the surface of the negative electrode, and the workability of the gel-polymer electrolyte e may be degraded.

Accordingly, there is required the development of a gel electrolyte composition showing higher power performance, improving the stability of a secondary battery, showing flame retardant performance, showing excellent workability, and showing an excellent adhesion property in the surface of the negative electrode.

### DISCLOSURE

### Technical Problem

To solve the problem, the present disclosure is to provide an energy storage device having excellent stability and performance by providing a gel electrolyte composition having flame retardant, including a fluorine-containing copolymer, and gelated on the surface of a negative electrode to prevent performance from being degraded due to the deterioration of the secondary battery and to more easily prepare a gel electrolyte, and by preparing a secondary battery including the gel electrolyte composition.

### Technical Solution

According to an embodiment of the present disclosure, there is provided a gel electrolyte composition including a fluorine-containing copolymer including repeating units represented by following Formula 1 and following Formula 2; lithium salt; and an organic solvent,

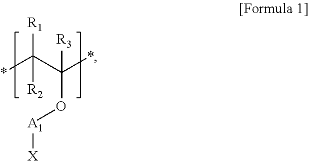

In Formula 1,
A₁ is *—C(═O)—*, *—C(═O)O—* or *—S(═O)₂—*,
each of R₁, R₂ and R₃ is independently hydrogen or C₁-C₆ straight-chain
or branched-chain alkyl, respectively,
X is *—F,

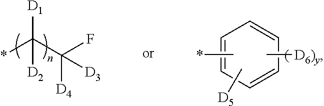

each of D₁, D₂, D₃ and D₄ is one independently selected from hydrogen, fluorine, C₁-C₆ straight-chain or branched-chain alkyl, and fluorinated C₁-C₆ straight-chain or branched-chain alkyl,

D₅ is one selected from fluorine, fluorinated C₁-C₁₂ straight-chain or branched-chain alkyl, and fluorinated C₁-C₁₂ straight-chain or branched-chain alkoxy,

D₆ is one selected from hydrogen, fluorine, fluorinated C₁-C₁₂ straight-chain or branched-chain alkyl, and fluorinated C₁-C₁₂ straight-chain or branched-chain alkoxy,
‘n’ is an integer ranging from 0 to 20, and
‘y’ is an integer ranging from 1 to 5,

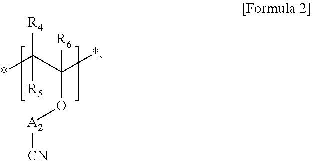

in Formula 2,
each of R₄, R₅ and R₆ is independently hydrogen or C₁-C₆ straight-chain or branched-chain alkyl, and
A₂ is C₁-C₆ straight-chain or branched-chain alkylene.

In addition, according to another embodiment of the present disclosure, there is provided a secondary battery including a positive electrode; a negative electrode; and the gel electrolyte composition, and the gel electrolyte composition includes a layer interposed between the positive electrode; and the negative electrode.

### Advantageous Effects

According to the present disclosure, the gel electrolyte composition includes the fluorine-containing copolymer to show the excellent flame retardant. Accordingly, the fire and the explosion of the secondary battery including the gel electrolyte composition may be prevented. In addition, even if charging and discharging are repeated, the degradation in the performance of the secondary battery may be minimized.

In addition, when the gel electrolyte composition according to the present disclosure is employed, the electrolyte SEI layer is formed on the negative electrode to prevent the degradation caused in the negative electrode. In addition, the side reaction with the electrolyte is prevented to realize the lifespan characteristic superior to that of the conventional secondary battery.

### DESCRIPTION OF DRAWINGS

FIG. 1A is a view illustrating a flame retardant characteristic of a gel electrolyte composition which is observed, according to a first embodiment;

FIG. 1B is a view illustrating a flame retardant characteristic of a gel electrolyte composition which is observed, according to a fourth embodiment;

FIG. 1C is a view illustrating a flame retardant characteristic of a gel electrolyte composition which is observed, according to a fifth embodiment;

FIG. 2 is a view illustrating a specific capacity and coulombic efficiency obtained while charging/discharging each of secondary batteries according to eleventh to fourteenth embodiments and a second comparative example for 600 cycles;

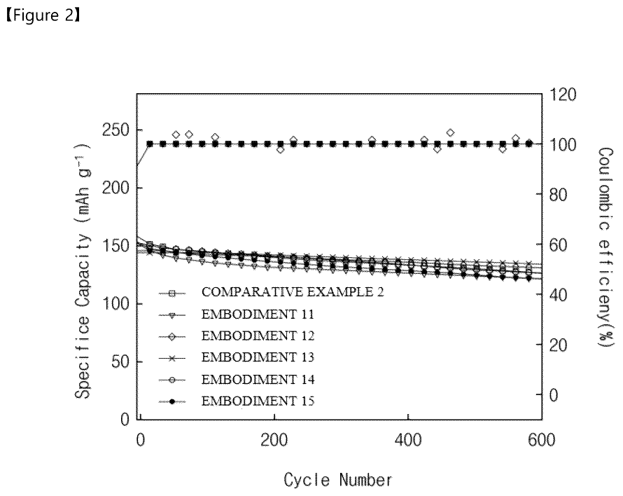

FIG. 3A is a view illustrating a voltage profile according to cycle progress of a secondary battery, according to an eleventh embodiment;

FIG. 3B is a view illustrating a voltage profile according to cycle progress of a secondary battery, according to a twelfth embodiment;

FIG. 3C is a view illustrating a voltage profile according to cycle progress of a secondary battery, according to a thirteenth embodiment;

FIG. 3D is a view illustrating a voltage profile according to cycle progress of a secondary battery, according to a fourteenth embodiment; and

FIG. 3E is a view illustrating a voltage profile according to cycle progress of a secondary battery, according to a fifteenth embodiment.

### MODE FOR INVENTION

Hereinafter, a gel electrolyte composition and a secondary battery including the same according to the present disclosure will be described in detail such that those skilled in the art to which the present disclosure pertains may easily reproduce the present disclosure.

According to an embodiment of the present disclosure, there is provided a gel electrolyte composition including a fluorine-containing copolymer including repeating units, which are represented by following Formula 1 and following Formula 2; lithium salt, and an organic solvent.

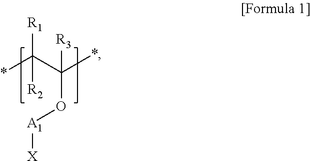

In Formula 1, A₁ is *—C(═)—*, *—C(═O)O—* or *—S(═O)₂—* and each of R₁, R₂ and R₃ is independently hydrogen or C₁-C₆ straight-chain or branched-chain alkyl, respectively, and X is *—F,

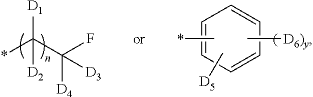

and each of D₁, D₂, D₃ and D₄ is one independently one selected from hydrogen, fluorine, C₁-C₆ straight-chain or branched-chain alkyl, and fluorinated C₁-C₆ straight-chain or branched-chain alkyl, D₅ is one selected from fluorine, fluorinated C₁-C₁₂ straight-chain or branched-chain alkyl, and fluorinated C₁-C₁₂ straight-chain or branched-chain alkoxy, and Do is one selected from hydrogen, fluorine, fluorinated C₁-C₁₂ straight-chain or branched-chain alkyl, and fluorinated C₁-C₁₂ straight-chain or branched-chain alkoxy, in which ‘n’ is an integer ranging from 0 to 20, and ‘y’ is an integer ranging from 1 to 5.

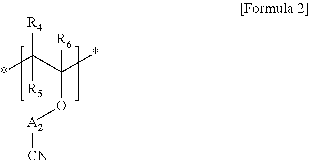

In Formula 2, each of R₄, R₅ and R₆ is independently hydrogen or C₁-C₆ straight-chain or branched-chain alkyl, and A₂ is C₁-C₆ straight-chain or branched-chain alkylene.

In this specification, the term ‘fluorination’ refers to that at least one hydrogen is substituted with fluorine.

In addition, according to one embodiment of the present disclosure, in Formula 1, each of R₁, R₂ and R₃ is independently hydrogen or C₁-C₃ straight-chain or branched-chain alkyl, and X is

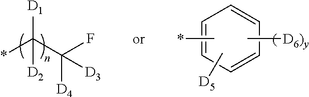

and,
each of D₁, D₂, D₃ and D₄ is independently one selected from hydrogen, fluorine, C₁-C₃ straight-chain or branched-chain alkyl, and fluorinated C₁-C₃ straight-chain or branched-chain alkyl, and D₅ is one selected from fluorine, fluorinated C₁-C₆ straight-chain or branched-chain alkyl, and fluorinated C₁-C₁₂ straight-chain or branched-chain alkoxy, and Do is one selected from hydrogen, fluorine, fluorinated C₁-C₆ straight-chain or branched-chain alkyl and fluorinated C₁-C₆ straight-chain or branched-chain alkoxy.

Specifically, in Formula 1, X is at least one selected from the group consisting of

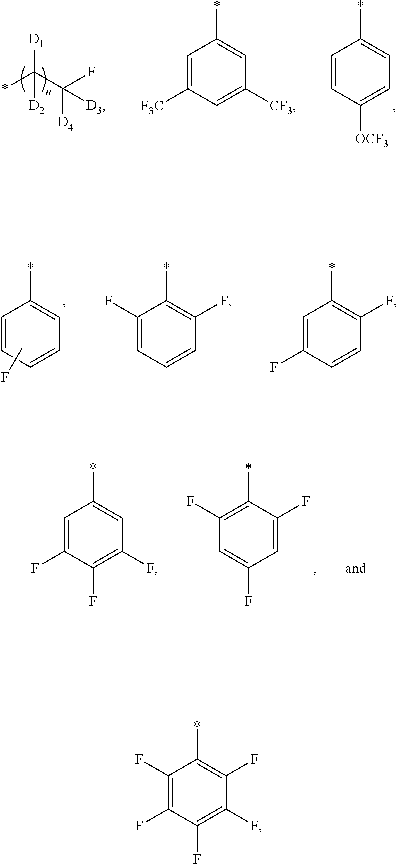

and
each of D₁, D₂, D₃ and D₄ is independently hydrogen, fluorine, methyl, *—CHF₂, *—CH₂F, or *—CF₃.

According to an embodiment of the present disclosure, in Formula 2, each of R₄, R₅, and R₆ is independently hydrogen or C₁-C₃ straight-chain or branched-chain alkyl, and A₂ is C₁-C₃ straight-chain alkyl.

According to the present disclosure, the gel electrolyte composition includes a fluorine-containing copolymer to suppress the reactivity of unpaired electrons formed in the polymer under a condition in which combustion may occur. Accordingly, the chain reaction of the gel electrolyte composition is stopped to prevent the combustion.

The fluorine-containing copolymer has a molar ratio of repeating units represented by Formula 1 and Formula 2, which ranges from 1:1 to 1:10, preferably 1:2 to 1:8, and more preferably 1:3 to 1:7. When the molar ratio of repeating units represented by Formula 1 and Formula 2 satisfies the above numerical value range, the prepared gel electrolyte may have the excellent flame retardant, such that the secondary battery including the gel electrolyte may be improved in stability and lifespan characteristic. In addition, crosslinking is immediately made inside the secondary battery by a cyano group contained in the fluorine-containing copolymer, thereby improving workability.

Meanwhile, the fluorine-containing copolymer may further include a repeating unit represented by following Formula 3.

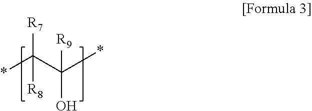

In Formula 3, each of R₇, R₈ and R₉ is independently hydrogen or C₁-C₆ straight-chain or branched-chain alkyl.

The fluorine-containing copolymer may include the repeating unit, which is represented by Formula 3, in the range from 0 to 30 mol %, preferably 0.5 to 20 mol %, more preferably 1 to 15 mol %, based on the total repeating units included in the copolymer. When the fluorine-containing copolymer includes the repeating unit represented by Formula 3 within the above numerical range, the fluorine-containing copolymer shows the excellent solubility with respect to an oil solvent. The hydroxyl group included in the fluorine-containing copolymer may more activate the reaction in which the lithium salt reacts with water to produce strong Lewis acid, and increase the crosslinking rate of the fluorine-containing copolymer.

Specifically, the crosslinking of the gel electrolyte composition may be made, as the cyano group of the fluorine-containing copolymer is bonded to a cyano group of another fluorine-containing copolymer. This crosslinking is made by allowing the lithium salt decomposed at high temperature to make with the hydroxyl group to form a stronger Lewis acid. Accordingly, the hydroxyl group may act as an initiator for the crosslinking of the cyano group.

In other words, when the repeating unit in Formula 3 containing a large amount of hydroxyl groups is included in the fluorine-containing copolymer in by above numerical range, a large amount of stronger Lewis acid derived from the lithium salt may be produced. Accordingly, the crosslinking rate may be increased.

The fluorine-containing copolymer may have a number average molecular weight ranging from 10,000 g/mol to 1,000,000 g/mol, preferably 10,000 to 300,000 g/mol, and more preferably 10,000 g/mol to 200,000 g/mol.

When the number average molecular weight of the fluorine-containing copolymer satisfies the above numerical range, the gel electrolyte may be realized with excellent ionic conductivity, excellent mechanical strength, excellent heat resistance, excellent electrical resistance, and excellent chemical resistance.

The fluorine-containing copolymer may be included in an amount of 0.1 to 10 wt parts, preferably 0.1 wt parts to 5 wt parts, and more preferably 1 to 5 wt parts, based on 100 wt parts of the gel electrolyte composition. As the gel electrolyte composition includes the fluorine-containing copolymer in the above numerical range, the gel electrolyte composition may not only have excellent crosslinking reactivity and flame retardant, but also have excellent lithium mobility due to the large amount of liquid electrolyte including lithium salt. Accordingly, electrical conductivity may be improved. Accordingly, even the secondary battery prepared by including the gel electrolyte composition may show excellent power, charging, and lifespan characteristics.

In the gel electrolyte according to the present disclosure, the fluorine- containing copolymer may be crosslinked under the presence of the lithium salt and the organic solvent. In particular, the gel electrolyte may be crosslinked in the secondary battery.

The lithium salt may be at least one selected from the group consisting of LiPF₆, LiClO₄, LiBF₄, LiFSI, LiTFSI, LiSO₃CF₃, LiBOB, LiFOB, LiDFOB, LiDFBP, LiTFOP, LiPO₂ F₂, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiSCN, and LiC(CF₃SO₂)₃, and preferably, may be at least one selected from the group consisting of LiPF₆, LiFSI, and LiDFOB.

As the gel electrolyte composition includes the lithium salt, the viscosity of the electrolyte may be lowered and more excellent crosslinkability may be shown.

As the lithium salt may be dissolved in the organic solvent, the lithium salt may have the concentration ranging from 0.5 to 3 M, preferably 0.8 to 1.5 M, and more preferably 0.8 to 1.2 M. When the concentration of the lithium salt satisfies the above numerical range, the fluorine-containing copolymer included in the gel electrolyte may have more excellent crosslinking reactivity. Accordingly, the secondary battery including the gel electrolyte may realize excellent charge/discharge capacity.

As long as the organic solvent is a compound containing a carbonate group, various organic solvents may be used. However, when the organic solvent includes the mixture of a cyclic carbonate-based compound and a linear carbonate-based compound, the excellent performance of the secondary battery may be realized.

Specifically, the organic solvent may include at least one selected from the group consisting of dimethyl carbonate (DMC), diethyl carbonate (DEC), dipropyl carbonate (DPC), methylpropyl carbonate (MPC), ethylpropyl carbonte (EPC), ethylmethyl carbonate (EMC), ethylene carbonate (EC), propylene carbonate (PC), and butylene carbonate (BC), and more particularly, at least one selected from the group consisting dimethyl carbonate (DMC), ethylmethyl carbonate (EMC), and ethylene carbonate (EC).

The ethylene carbonate (EC) is a cyclic carbonate-based compound, and a gel electrolyte composition including the ethylene carbonate may be controlled in viscosity, may dissociate the lithium salt, and may show a higher dielectric constant. Accordingly, the charge/discharge capacity of the secondary battery including the gel electrolyte composition may be increased.

The ethyl methyl carbonate (EMC) is a linear carbonate-based compound and has a lower freezing point and a higher boiling point.

Accordingly, a gel electrolyte composition including the ethyl methyl carbonate (EMC) may have an excellent low-temperature characteristic, may prevent low-temperature discharge of the secondary battery, and may increase the cycle lifespan of the battery.

For example, the organic solvent may have a volume ratio of ethylene carbonate and ethyl methyl carbonate, which ranging from 1:1 to 1:10, preferably 1:1 to 1:5, and more preferably 1:2 to 1:3. When the ethylene carbonate and the ethyl methyl carbonate included in the organic solvent are mixed in the volume ratio range, the organic solvent may have the higher dielectric constant, an excellent lithium salt dissociation characteristic, and an excellent lower-temperature characteristic.

The gel electrolyte composition may be crosslinked at the temperature ranging from 20° C. to 80° C., preferably 30° C. to 80° C., and more preferably 40° C. to 70° C. When the crosslinking temperature of the gel electrolyte composition satisfies the above numerical range, a crosslinking reaction rate is increased and a gel polymer electrolyte having an excellent mechanical property may be prepared.

A method for preparing the fluorine-containing copolymer may be performed by allowing a base copolymer including repeating units represented by Formulas 2 and 3 to react with a fluorine-containing compound.

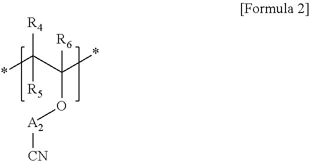

In Formula 2, R₄, R₅ and R₆ are each independently hydrogen or C₁-C₆ straight-chain or branched-chain alkyl, and A₂ is C₁-C₆ straight-chain or branched-chain alkylene.

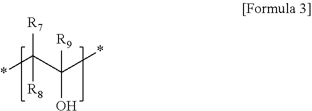

In Formula 3, each of R₇, R₈ and R₉ is independently hydrogen or C₁-C₆ straight-chain or branched-chain alkyl.

The fluorine-containing copolymer may be prepared by allowing a hydroxyl group included in the base copolymer to react with the fluorine-containing compound. Depending on the mass ratio of the base copolymer and the fluorine-containing compound, the content of the repeating unit represented by Formula 3 may be adjusted or the repeating unit is not included.

The fluorine-containing compound may include at least one functional group selected from a carboxyl group (*—COOH; —COO [halogen]), a carbonate group (*—COO—*) and a sulfone group (*—SOOH; *—SOO [halogen]). The fluorine-containing copolymer prepared by reacting with the base copolymer may include one bonding structure selected from *—C(═O)—*, *—C(═O)O—* or *—S(═O)₂—*.

Specifically, the fluorine-containing compound may include at least one one selected from the group consisting of 4-(trifluoromethoxy) benzoic acid, pentafluorobenzoic acid, bis(pentafluorophenyl) carbonate, trifluoromethanesulfonyl chloride, bis(trifluoromethyl)benzenesulfonyl chloroide, pentafluorobenzenesulfonyl chloride, pentafluorobenzyl bromide, heptafluorobutyryl chloride, bis(2,2,2-trifluoroethyl)carbonate, pentafluorobenzoyl chloride, bis(pentafluorophenyl) carbonate, trifluoroethyl methacrylate, heptafluoro-1-butanol, 4-(trifluoromethoxy) benzenesulfonyl chloride, and 4-(trifluoromethoxy) benzoic acid.

The fluorine-containing copolymer prepared through substitution with the fluorine-containing compound has a higher fluorine content, which shows the excellent heat resistance and the flame retardant. Accordingly, the secondary battery prepared by including the fluorine-containing copolymer may have an excellent lifespan characteristic and stability.

The fluorine-containing copolymer may be prepared through an ester reaction (DCC coupling, reaction of carbonates with alcohol, and reaction of sulfonyl chloride with alcohol) between the base copolymer and the fluorine-containing compound. The ester reaction may proceed with a coupling agent participating in the reaction.

Various coupling agents may be employed depending on the type of functional group of the fluorine-containing compound. For example, dicyclohexylcarbodiimide may be preferable for an ester bond, triethylamine may be preferable for a carbonate bond, and pyridine may be preferable for a sulfonic bond.

The coupling agent may be a carbodiimide-based, pyridine-based, or amine-based coupling agent. Specifically, the coupling agent may be at least one selected from the group consisting of dicyclohexylcarbodiimide (DCC), ethyldimethylaminopropyl carboximide, hydroxysuccinimide, diisopropylcarbodiimide (DIC), 4-dimethylaminopyridine (DMAP), pyridine, triethylamine, and 2-chloro-1-methylpyridinium iodine. Preferably, the coupling agent may be at least one selected from the group consisting of dicyclohexylcarbodiimide, 4-dimethylaminopyridine, triethylamine and pyridine.

The method for preparing the fluorine-containing copolymer may be performed by including an aprotic organic solvent. The aprotic organic solvent may include at least one selected from the group consisting of acetone, acetonitrile, dichloromethane, dimethylformamide, dimethylpropylene urea, dimethylsulfoxide, ethyl acetate, hexamethylphosphate triamide, pyridine, sulfolane and tetrahydrofuran, and is not necessarily limited thereto as long as the aprotic organic acid allows the synthesis of the fluorine-containing copolymer.

The method for preparing the fluorine-containing copolymer may be shown through following Preparation Equations 1 to 7 by way of example.

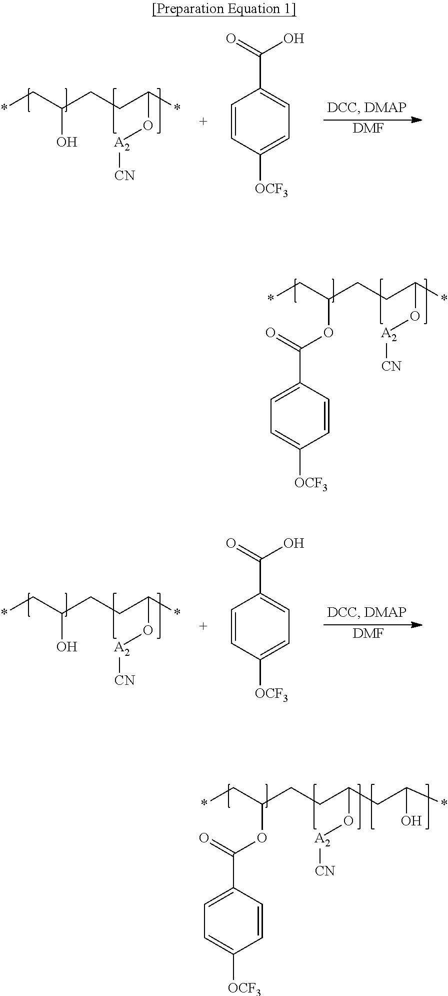

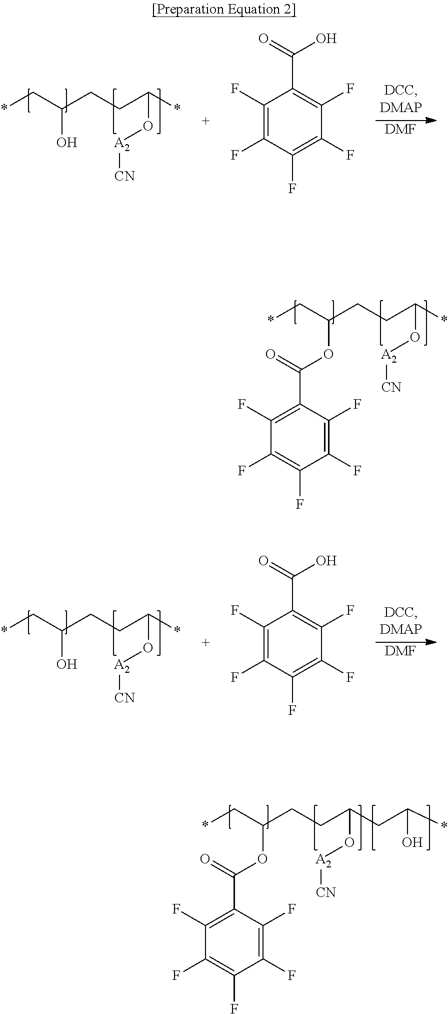

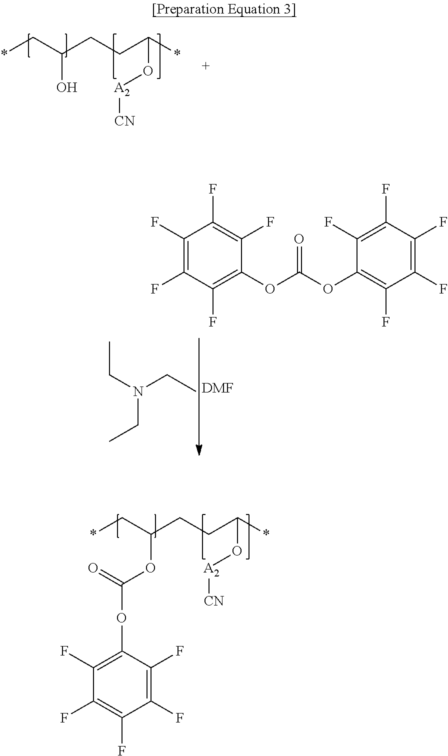

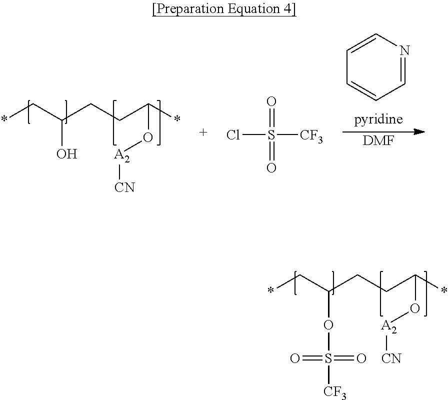

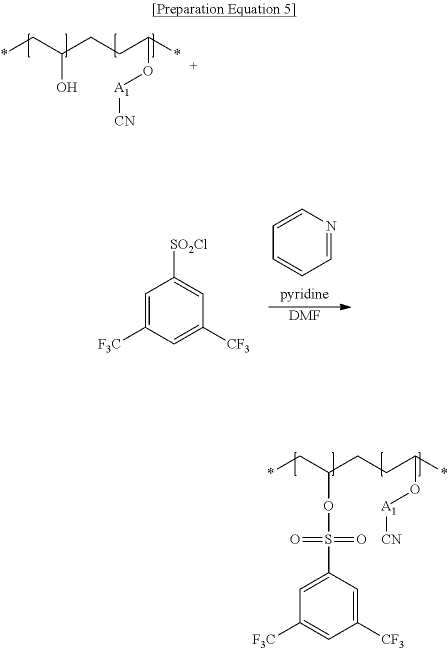

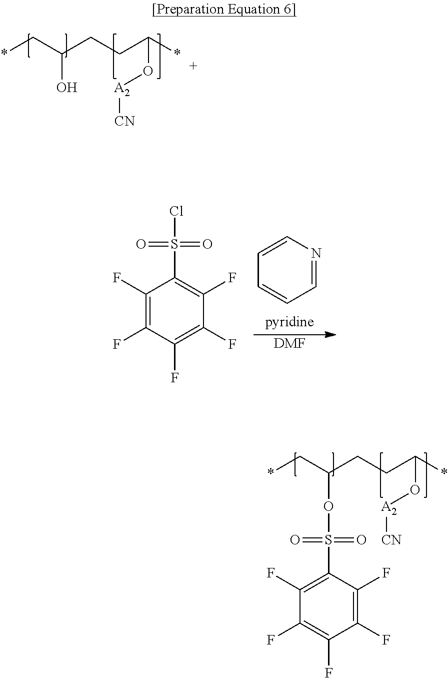

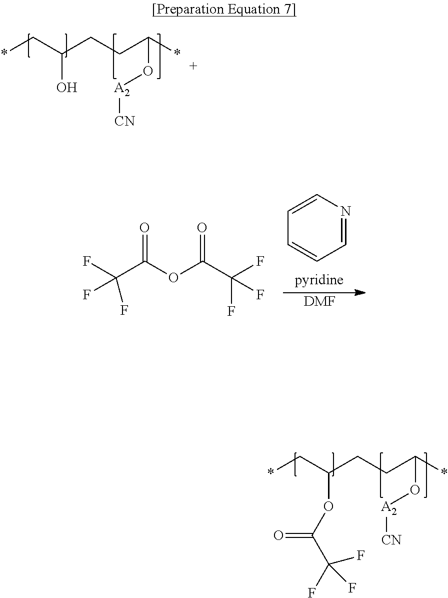

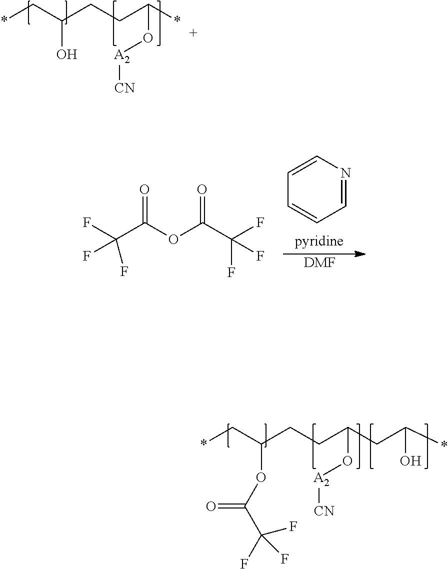

A₁ is C₁-C₆ alkylene.

The content of the vinyl alcohol repeating unit included in the fluorine-containing copolymer may vary depending on the molar ratio of the base copolymer and the fluorine-containing compound in Preparation Formulas 1 to 7, and may not be included if necessary. Specifically, when the molar ratio of the base copolymer and the fluorine-containing compound is in the range from 1:2 to 1:5, the reaping unit of the vinyl alcohol may not be included, and when the molar ratio deviates from the range 1:1 to less than 1:2, the repeating unit of the vinyl alcohol may be included. The vinyl alcohol repeating unit may be included in an equal content or different contents depending on the reacting fluorine-containing compound.

According to another embodiment of the present disclosure, there is provided a secondary battery including the positive electrode, the negative electrode, and the gel electrolyte composition. The gel electrolyte composition forms a layer between the positive electrode and the negative electrode.

The secondary battery includes the flame retardant gel electrolyte composition, which has excellent heat resistance and excellent flame retardant, between the positive electrode and the negative electrode, thereby preventing the positive electrode and the negative electrode from being shorted to exhibit excellent stability.

In addition, in the secondary battery, during the charging process, the lithium salt included in the gel electrolyte composition is dissociated to produce lithium ions, the lithium ions and react with another compound included in the gel electrolyte composition, thereby forming a solid electrolyte interphase (SEI) layer on the surface of the negative electrode, and realizing the excellent mobility of the lithium on the surface of the negative electrode. Accordingly, the capacity retention rate of the secondary battery may be improved.

The secondary battery may satisfy following Equation 1.

$${C}_{600} / {C}_{1 \geq } 0.8 \qquad [ Equation 1 ]$$

In Equation 1,
C₆₀₀ is the discharge capacity of the secondary battery after charging and discharging operations are repeatedly performed 600 times,
C₁ is the discharge capacity of the secondary battery after the charging and discharging operations are performed at one time.

Specifically, Equation 1 represents the charge/discharge capacity of the secondary battery. In Equation 1, the C₆₀₀/C₁ value may be 0.85 to 0.98, which refers to that the secondary battery has excellent lifespan characteristic, as compared to a conventional secondary battery.

The positive electrode active material included in the positive electrode may include at least one selected from the group consisting of nickel, cobalt, manganese, tin, silicon and aluminum, and preferably may include the alloy of lithium, nickel, manganese, and cobalt in terms of overcoming the advantages and disadvantages of each metal.

The negative electrode active material included in the negative electrode may include at least one selected from the group consisting of graphite, silicon, germanium, tin, and antimony, and preferably may include graphite.

The gel electrolyte composition may be formed through gelation on the surface of the negative electrode. Accordingly, even if the gel electrolyte composition according to the present disclosure is applied, the stable solid electrolyte interphase (SEI) layer may be formed on the negative electrode. Accordingly, the decomposition of the electrolyte may be prevented, and the movement of the lithium ion may be smoothly accelerated, thereby improving the performance and the lifespan of the lithium secondary battery.

Hereinafter, the present disclosure will be described in more detail through embodiments. However, the embodiments are provided only for the illustrative purpose, and the scope of the present disclosure is not limited to the embodiments in any sense.

### <Embodiment 1> Preparation 1 of Gel Electrolyte Composition

In a 50 mL round bottom flask, 12 mL of N,N-Dimethylmethanamide (DMF) and 1 g (0.0055 mol) of Poly[Vinylachol-co-3-(vinyloxy) propanenitrile] (weight average molecular weight: 1.1058×10⁵ g/mol; vinyl alcohol repeating unit: 24.2 mol %) was added and stirred.

Thereafter, 1.36 g (0.066 mol) of 4-(trifluoromethoxy)benzoic acid and 2.26 g (0.011 mol) of N, N′-Dicyclohexylcarbodiimide (DCC), which are fluorine-containing compounds listed in following Table 1, were added to the stirred mixture, After immersing a round bottom flask, which contains the mixture, in a water bath containing ice water, 0.0559 g (0.0004572 mol) of DMAP (4-Dimethylaminopyridine) was dissolved in 3 mL of DMF, which was slowly added to the round bottom flask and stirred for 10 minutes.

After 10 minutes, the mixture was stirred and reacted at room temperature for 24 hours. After the reaction was completed, a precipitate was filtered, and a remaining polymer solution was precipitated in ethanol, and then dried in a vacuum oven at 60° C. to prepare a fluorine-containing copolymer.

0.03 g of the prepared fluorine-containing copolymer was added to 1.47 g of an organic solvent (an organic solvent in which ethylene carbonate (EC) and ethyl methyl carbonate (EMC) were mixed at a volume ratio of 3:7) containing 1M of LiPF₆, which is lithium salt, and mixed. Thereafter, a crosslinking reaction was performed at a temperature of 60° C. to prepare a gel electrolyte composition.

### <Embodiment 2> Preparation 2 of Gel Electrolyte Composition

A gel electrolyte composition was prepared in the same manner as in Embodiment 1, except that 0.907 g (0.0044 mol) of 4-(trifluoromethoxy)benzoic acid, which is a fluorine-containing compound, was added.

### <Embodiment 3> Preparation 3 of Gel Electrolyte Composition

A gel electrolyte composition was prepared in the same manner as in Embodiment 1, except that 2.3329 g (0.011 mol) of pentafluorobenzoic acid, which is a fluorine-containing compound, was added.

### <Embodiment 4> Preparation 4 of Gel Electrolyte Composition

A gel electrolyte composition was prepared in the same manner as in Embodiment 1, except that 0.9331 g (0.0044 mol) of pentafluorobenzoic acid, which is a fluorine-containing compound, was added.

### <Embodiment 5> Preparation 5 of Gel Electrolyte Composition

In a 50 mL round bottom flask, 15 mL of N,N-Dimethylmethanamide (DMF) and 1 g (0.0055 mol) of Poly[Vinylachol-co-3-(vinyloxy) propanenitrile] (weight average molecular weight: 1.1058×10⁵ g/mol; vinyl alcohol repeating unit: 24.2 mol %) was added and stirred.

Thereafter, 2.2 mL (0.0165 mol) of triethylamine (TEA) was added to the stirred mixture, and then 3.2514 g (0.00825 mol) of Bis (pentafluorophenyl) carbonate, which is a fluorine-containing compound, was added and then reacted at room temperature for 72 hours.

After the reaction was completed, a precipitate was filtered, and a remaining polymer solution was precipitated in ethanol and dried in a vacuum oven at 60° C. to prepare a fluorine-containing copolymer.

0.03 g of the prepared fluorine-containing copolymer was added to 1.47 g of an organic solvent (an organic solvent in which ethylene carbonate (EC) and ethyl methyl carbonate (EMC) were mixed at a volume ratio of 3:7) containing 1M of LiPF₆ which is lithium salt and mixed. Thereafter, a crosslinking reaction was performed at a temperature of 60° C. to prepare a gel electrolyte composition.

### <Embodiment 6> Preparation 6 of Gel Electrolyte Composition

In a 50 mL round bottom flask, 15 mL of DMF (N,N-Dimethylmethanamide) and 1 g (0.0055 mol) of Poly[Vinylachol-co-3-(vinyloxy propanenitrile] (weight average molecular weight: 1.1058×10⁵ g/mol, vinyl alcohol: 24.2 mol %) was added and stirred.

Then, after adding pyridine (2.75 ml; 0.0275 mol) to the stirred mixture, 0.88 mL (1.39 g; 0.00825 mol) of trifluoromethanesulfonyl chloride, a fluorine-containing compound shown in Table 1 was slowly added, and reacted for 46hours.

After the reaction was completed, the precipitate was filtered, and a remaining polymer solution was precipitated in ethanol and dried in a vacuum oven at 60° C. to prepare a fluorine-containing copolymer.

0.03 g of the prepared fluorine-containing copolymer was added to 1.47 g of an organic solvent (an organic solvent in which ethylene carbonate (EC) and ethyl methyl carbonate (EMC) were mixed at a volume ratio of 3:7) containing 1M of LiPF₆, which is lithium salt, and mixed. Thereafter, a crosslinking reaction was performed at a temperature of 60° C. to prepare a gel electrolyte composition.

### <Embodiment 7> Preparation 7 of Gel Electrolyte Composition

A gel electrolyte composition was prepared in the same manner as in Embodiment 6, except that 2.579 g (0.00825 mol) of Bis(trifluoromethyl)benzenesulfonyl chloride of a fluorine-containing compound was added and the mixed solution was reacted at a room temperature for 72 hours.

### <Embodiment 8> Preparation 8 of Gel Electrolyte Composition

A gel electrolyte composition was prepared in the same manner as in Embodiment 7, except that 1.2 mL (2.2 g, 0.00825 mol) of pentafluorobenzenesulfonyl chloride was added as a fluorine-containing compound.

### <Embodiment 9> Preparation 9 of Gel Electrolyte Composition

A gel electrolyte composition was prepared in the same manner as in Embodiment 5, except that 1.329 mL (0.0165 mol) of pyridine and 0.1 g (0.00825 mol) of DAMP were used instead of TEA as a solvent, and 1.73 g (0.00825 mol) of Trifluoroacetic anhydride which is a fluorine-containing compound, was added. A gel electrolyte composition was prepared.

### <Embodiment 10> Preparation 10 of Gel Electrolyte Composition

A gel electrolyte composition was prepared in the same manner as in Embodiment 9, except that 0.58 g (0.00275 mol) of trifluoroacetic anhydride which is a fluorine-containing compound was added.

### <Comparative Example 1> Preparation 11 of Gel Electrolyte Composition

A gel electrolyte composition was prepared in the same manner as in Embodiment 1, except that the fluorine-containing copolymer was not included.

### <Experimental Example 1> Evaluation of Flame Retardant

After preparing the gel electrolyte compositions according to Embodiments 1 to 10 and Comparative Example 1 as specimens in 10 mm×10 mm×10 mm, the gel electrolyte compositions were repeatedly burnt with a 1.20 mm flame for 1 second 4 times to observe combustion. The results are shown in following Table 1. When combustion did not occur, ‘O’ was marked, and when combustion occurred, ‘X’ was marked.

TABLE 1

| | Functional group substitution compound of PVA-CN | | | |
|---|---|---|---|---|
| | | | Whether | |
| | | | vinyl | |
| | | | alcohol | |
| | | | repeating | |
| | | Amount | unit is | Flame |
| | compound name | added | include | retardant |
| Embodiment 1 | 4-(Trifluoromethoxy)benzoic | 1.36 g | Not | ∘ |
| | acid | (0.066 | included | |
| | | mol) | | |
| Embodiment 2 | 4-(Trifluoromethoxy)benzoic | 0.907 g | Included | ∘ |
| | acid | (0.0044 | | |
| | | mol) | | |
| Embodiment 3 | Pentafluorobenzoic acid | 2.3329 g | Not | ∘ |
| | | (0.011 mol) | included | |
| Embodiment 4 | Pentafluorobenzoic acid | 0.9331 g | Included | ∘ |
| | | (0.0044 | | |
| | | mol) | | |
| Embodiment 5 | Bis(pentafluorophenyl) | 3.2514 g | Not | ∘ |
| | carbonate | (0.00825 | included | |
| | | mol) | | |
| Embodiment 6 | Trifluoromethanesulfonyl | 1.39 g | Not | ∘ |
| | chloride | (0.0082 | included | |
| | | 5 mol) | | |
| Embodiment 7 | Bis(trifluoromethyl)benzenesulfonyl | 2.579 g | Not | ∘ |
| | chloride | (0.00825 | included | |
| | | mol) | | |
| Embodiment 8 | Pentafluorobenzenesulfonyl | 2.2 g | Not | ∘ |
| | chloride | (0.00825 | included | |
| | | mol) | | |
| Embodiment 9 | Trifluoroacetic anhydride | 1.73 g | Not | ∘ |
| | | (0.00825 | included | |
| | | mol) | | |
| Embodiment 10 | Trifluoroacetic anhydride | 0.58 g | Included | |
| | | (0.00275 | | |
| | | mol) | | |
| Comparative | carbonate liquid electrolyte | x | x | x |
| Example 1 | | | | |

Embodiments 1 to 10 are gel electrolyte compositions containing a fluorine-containing copolymer, and Comparative Example 1 is a gel electrolyte composition of a copolymer of acrylonitrile-ethylene oxide.

In Table 1, it was recognized that all of Embodiments 1 to 10 had excellent flame retardant, as compared to Comparative Example 1, which is exhibited as the fluorine-containing copolymer included in the gel electrolyte composition of Embodiments 1 to 10 includes a fluorine substituent.

Meanwhile, the gel electrolyte compositions according to Embodiments 1 to 10 show excellent flame retardant, Accordingly, it may be recognized that the flame retardant is excellent regardless of the bonding with *—C(═O)O—*, *—OC(═O)O—* and *—S(═O)—* included in the fluorine-containing copolymer.

In addition, when comparing between Embodiments 1 and 2, Embodiments 3 and 4, and Embodiments 9 and 10, which are different from each other in the presence of the vinyl alcohol repeating unit, it was recognized that all the gel electrolyte compositions according to Embodiments 1 to 10 have excellent flame retardant regardless of the presence of the vinyl alcohol repeating unit.

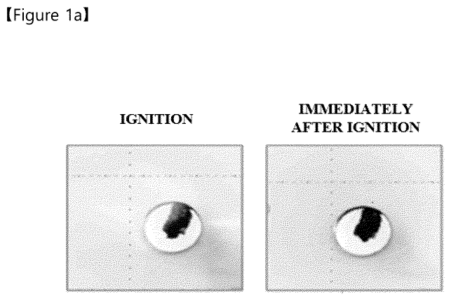

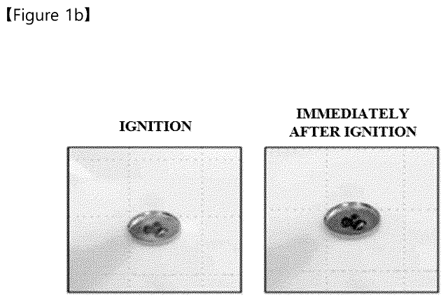

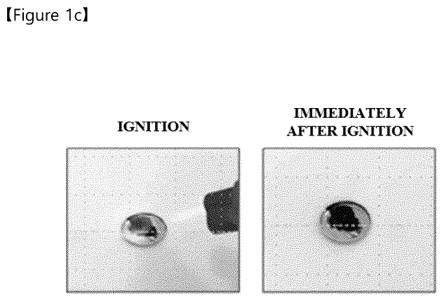

FIGS. 1A to 1C are photographs showing the evaluation result of the flame retardant according to Embodiment 1, Embodiment 4, and Embodiment 5 including the fluorine-containing copolymer containing an aryl group, and the excellent flame retardant may be recognized.

### <Embodiment 11> Preparation 1 of Secondary Battery Containing Gel Electrolyte

A secondary battery was prepared using LiNi_{0.6}Co_{0.2}Mn_{0.2}O₂ (NCM 622) as a positive electrode, graphite for a negative electrode, and a gel electrolyte composition according to Embodiment 1.

Regarding the preparation of the NCM 622, LiNi_{0.6}Co_{0.2}Mn_{0.2}:PVDF:super-P was mixed in a mass ratio of 94:3:3 and the mixture was uniformly dissolved in N-methyl-2-pyrrolidone (NMP) to prepare a slurry. The prepared slurry was coated on aluminum foil and dried in a vacuum oven at 120° C. for 24 hours, thereby preparing the positive electrode. After loading the prepared positive electrode at a density of 12 mg/cm ², the positive electrode is punched in the shape of a circle having a diameter of 14 mm and used in a coin-type cell.

Regarding the negative electrode, graphite:PVDF:carbon black (Super p) were mixed in a mass ratio of 94:3:3 and then uniformly dissolved in N-methyl-2-pyrrolidone (NMP) to prepare a slurry. The prepared slurry was coated on a copper foil and dried in a vacuum oven at 120° C. for 24 hours, thereby preparing the negative electrode. After loading the prepared negative electrode at a density of 6 mg/cm ², the negative electrode is punched in the shape of a circle having a diameter of 16 mm and used in a coin-type cell.

Thereafter, the gel electrolyte composition according to Embodiment 1 was interposed between the positive electrode and the negative electrode to complete a coin-type secondary battery.

It was recognized that a solid electrolyte interphase (SEI) layer was formed on the surface of the negative electrode and then LiF was included in the SEI layer.

### <Embodiment 12> Preparation 2 of Secondary Battery Containing Gel Electrolyte

The secondary battery was prepared in the same manner as in Embodiment 11, except that the gel electrolyte composition according to Embodiment 3 was applied instead of the gel electrolyte composition according to Embodiment 1.

### <Embodiment 13> Preparation 3 of Secondary Battery Containing Gel Electrolyte

A secondary battery was prepared in the same manner as in Embodiment 11, except that the gel electrolyte composition according to Embodiment 4 was applied, instead of the gel electrolyte composition according to Embodiment 1.

### <Embodiment 14> Preparation 4 of Secondary Battery Containing Gel Electrolyte

A secondary battery was prepared in the same manner as in Embodiment 11, except that the gel electrolyte composition according to Embodiment 5 was applied, instead of the gel electrolyte composition according to Embodiment 1.

### <Embodiment 15> Preparation 5 of Secondary Battery Containing Gel Electrolyte

A secondary battery was prepared in the same manner as in Embodiment 11, except that the gel electrolyte composition according to Embodiment 9 was applied, instead of the gel electrolyte composition according to Embodiment 1.

### <Comparative Example 2> Preparation 6 of Secondary Battery Containing Gel Electrolyte

A polymer-type battery was prepared through a conventional method with the prepared positive electrode, the prepared negative electrode, and a separator having three layers of polypropylene/polyethylene/polypropylene (PP/PE/PP). Then, LiPF6 electrolyte was dissolved at the concentration of 1 M in the mixture of ethylene carbonate (EC), diethyl carbonate (DEC), and ethyl methyl carbonate (EMC), such that the volume ratio of ethylene carbonate (EC):diethyl carbonate (DEC):ethyl methyl Carbonate (EMC)=4:3:3 to prepare a non-aqueous electrolyte solution, and the non-aqueous electrolyte solution was injected, thereby preparing the lithium secondary battery.

### <Experimental Example 2> Secondary Battery Constant Current Test Method

After the coin-type secondary battery was charged and discharged once under conditions of a driving temperature of 25° C., a voltage ranging from 3 V to 4.2 V, and a charge/discharge rate of 0.1 C-rate (165 mA/g), a gelation reaction was started. Thereafter, charging and discharging were performed 600 times under the condition of a charge/discharge rate of 0.5 C-rate, a discharge capacity during one cycle of charging and discharging operations, and a discharge capacity during 600 cycles of charging and discharging operations were measured, and the discharge capacities were calculated through Equation 1.

$$Capacity retention rate ( \% ) = ( discharge capacity during 600 cycles \text{} / discharge capacity at 1 cycle ) \times 100 \qquad [ Equation 1 ]$$

The calculation results are shown in following Table 2

TABLE 2

| | | Functional group | Capacity |
|---|---|---|---|
| | Gel | substitution compound of | retention rate |
| | electrolyte | PVA-CN | (%) |
| Embodiment | Embodiment 1 | 4- | 81.4 |
| 11 | | (Trifluoromethoxy)benzoic | |
| | | acid | |
| Embodiment | Embodiment 3 | Pentafluorobenzoic acid | 82.95 |
| 12 | | | |
| Embodiment | Embodiment 4 | Pentafluorobenzoic acid | 91.5 |
| 13 | | | |
| Embodiment | Embodiment 5 | Bis(pentafluorophenyl) | 86.6 |
| 14 | | carbonate | |
| Embodiment | Embodiment 9 | Trifluoroacetic anhydride | 87.3 |
| 15 | | | |
| Comparative | Comparative | liquid electrolyte | 80.3 |
| Example 2 | Example 1 | | |

The capacity retention rate in Table 2 shows the change in discharge capacity after 600 cycles of the charging and discharging operations, which is a measured value inferring the lifespan characteristics of the secondary battery.

In Table 2, it was recognized that Embodiments 11 to 15 include the gel electrolyte compositions according to Embodiments 1, 3 to 5, and 9, respectively, and the capacity retention rate of the secondary battery is at least 81%, which is specifically at least 85% in Embodiments 13 to 15. This is because the secondary batteries according to Embodiments 11 to 15 include a SEI layer stable by containing the gel electrolyte compositions according to Embodiments 1, 3 to 5, and 9, thereby preventing the negative electrode from being deteriorated, such that the side reaction with the electrolyte is prevented, such that a more excellent capacity retention rate may be obtained.

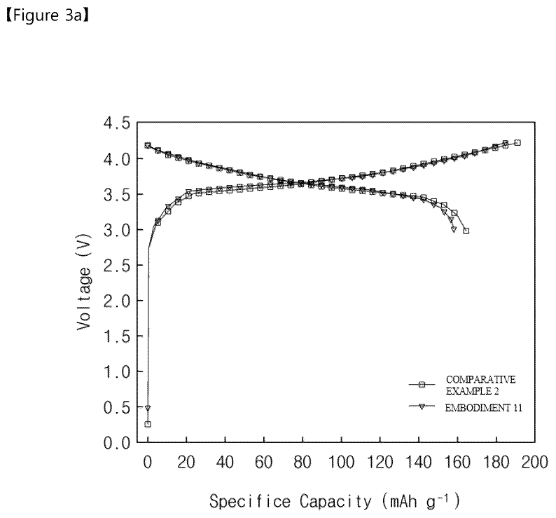

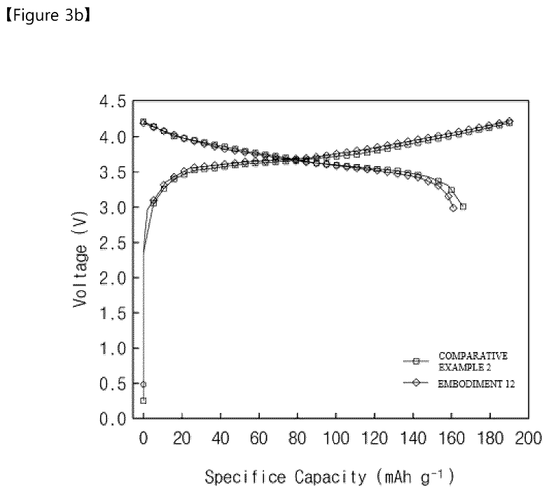

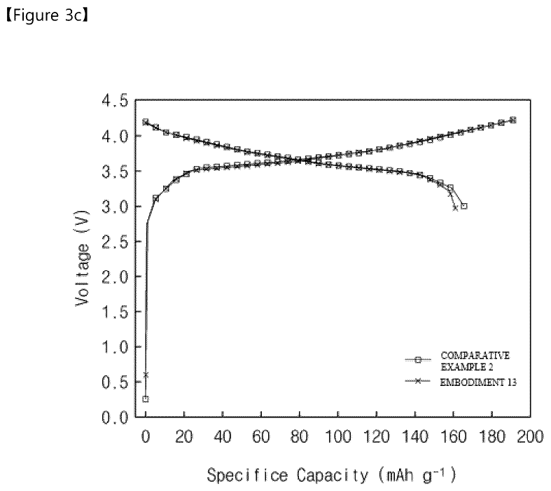

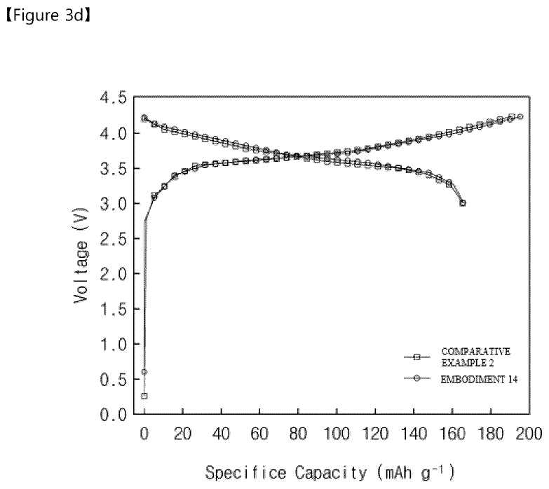

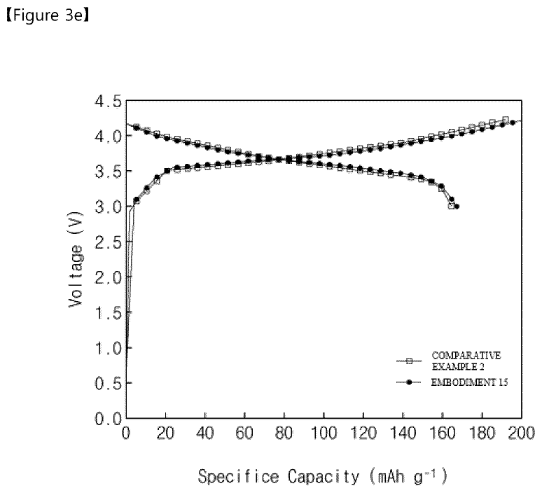

Meanwhile, FIGS. 3A to 3D illustrates capacitance-voltage graphs of

Embodiments 11 to 15 under the condition of an initial discharge/charge rate of 0.1 C-rate. Accordingly, an amount of SEI layer, which is formed at the initial stage of the charging/discharging operation, may be inferred through the comparison in capacity between secondary batteries according to Embodiment 11 to Embodiment 15 and the calculation of the coulombic efficiency of the secondary batteries according to Embodiment 11 to Embodiment 15, and an amount of an overvoltage formed in each battery may be determined. A lower voltage is more advantageous in the capacity range of 0 mAh/g to 10 mAh/g, and the lowest voltage was showed in Embodiment 13. In addition, the highest capacity retention rate was showed in Embodiment 13.

Therefore, the gel electrolyte composition according to the present disclosure includes the fluorine-containing copolymer to show the excellent flame retardant. Accordingly, the secondary battery including the gel electrolyte composition may be improved to prevent the fire and the explosion of the secondary battery. In addition, when the gel electrolyte composition according to the present disclosure is used, the stable SEI layer is formed on the negative electrode to prevent the negative electrode from being deteriorated. In addition, the side reaction with the electrolyte may be prevented such that a more excellent lifespan characteristic is realized as compared to a conventional secondary battery.

1. A gel electrolyte composition comprising:
a fluorine-containing copolymer including repeating units represented by following Formula 1 and following Formula 2;
lithium salt; and
an organic solvent, 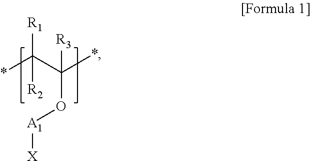
in which, in Formula 1, A₁ is *—C(═O)—*, *—C(═O)O—* or *—S(═O)₂—*.
each of R₁, R₂ and R₃ is independently hydrogen or C₁-C₆ straight-chain or branched-chain alkyl, respectively,
X is *—F, 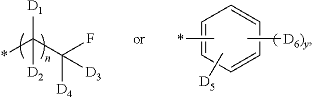
each of D₁, D₂, D₃ and D₄ is which is one independently selected from hydrogen, fluorine, C₁-C₆ straight-chain or branched-chain alkyl, and fluorinated C₁-C₆ straight-chain or branched-chain alkyl,
D₅ is one selected from fluorine, fluorinated C₁-C₁₂ straight-chain or branched-chain alkyl, and fluorinated C₁-C₁₂ straight-chain or branched-chain alkoxy,
D₆ is one selected from hydrogen, fluorine, fluorinated C₁-C₁₂ straight-chain or branched-chain alkyl, and fluorinated C₁-C₁₂ straight-chain or branched-chain alkoxy,
‘n’ is an integer ranging from 0 to 20, and
‘y’ is an integer ranging from 1 to 5, 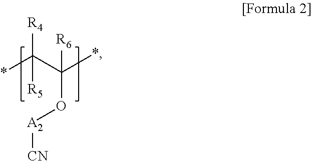
in which, in Formula 2,
R₄, R₅ and R₆ are each independently hydrogen or C₁-C₆ straight-chain or branched-chain alkyl, and
A₂ is C₁-C₆ straight-chain or branched-chain alkylene.

2. The gel electrolyte composition of claim 1, wherein the fluorine-containing copolymer further includes a repeating unit represented by following Formula 3, 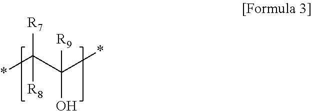
in which, in Formula 3, each of R₇, R₈ and R₉ is independently hydrogen or C₁-C₆ straight-chain or branched-chain alkyl,

3. The gel electrolyte composition of claim 1, wherein
each of R₁, R₂ and R₃ is independently hydrogen or C₁-C₃ straight-chain or branched-chain alkyl, respectively,
X is 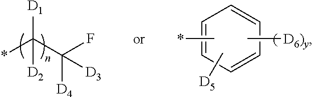
each of D₁, D₂, D₃ and D₄ is one independently selected from hydrogen, fluorine, C₁-C₃ straight-chain or branched-chain alkyl, and fluorinated C₁-C₃ straight-chain or branched-chain alkyl,
D₅ is one selected from fluorine, fluorinated C₁-C₆ straight-chain or branched-chain alkyl, and fluorinated C₁-C₁₂ straight-chain or branched-chain alkoxy, and
D₆ is one selected from hydrogen, fluorine, fluorinated C₁-C₆ straight-chain or branched-chain alkyl, and fluorinated C₁-C₆ straight-chain or branched-chain alkoxy.

4. The gel electrolyte composition of claim 1, wherein X is at least one selected from the group consisting of 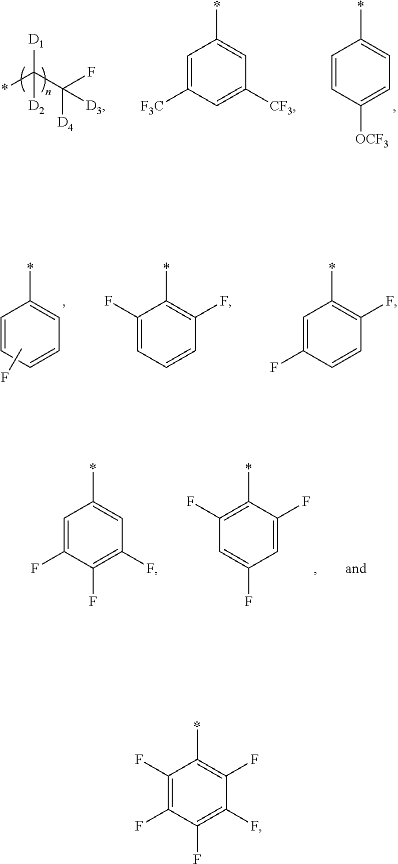
and
each of D₁, D₂, D₃ and D₄ is independently hydrogen, fluorine, methyl, *—CHF₂, *—CH₂F, or *—CF₃.

5. The gel electrolyte composition of claim 1, wherein each of R₄, R₅, and R₆ is independently hydrogen or C₁-C₃ straight-chain or branched-chain alkyl, and
A₂ is C₁-C₃ straight-chain alkyl.

6. The gel electrolyte composition of claim 1, wherein the fluorine-containing copolymer has a molar ratio of repeating units represented by Formula 1 and Formula 2, which ranges from 1:1 to 1:10.

7. The gel electrolyte composition of claim 2, wherein the fluorine-containing copolymer includes a repeating unit, which is represented by Formula 3, in less than 30 mol %, based on total repeating units included in the copolymer

8. The gel electrolyte composition of claim 1, wherein the fluorine-containing copolymer has a number average molecular weight ranging from 10,000 g/mol to 1,000,000 g/mol.

9. The gel electrolyte composition of claim 1, wherein the fluorine-containing copolymer is included in an amount of 0.1 wt parts to 10 wt parts, based on 100 wt parts of the gel electrolyte composition.

10. The gel electrolyte composition of claim 1, wherein the lithium salt is at least one selected from the group consisting of LiPF₆, LiClO₄, LiBF₄, LiFSI, LiTFSI, LiSO₃CF₃, LiBOB, LiFOB, LiDFOB, LiDFBP, LiTFOP, LiPO₂F₂, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiSCN, and LiC(CF₃SO₂)₃.

11. The gel electrolyte composition of claim 1, wherein the organic solvent includes at least one selected from the group consisting of dimethyl carbonate (DMC), diethyl carbonate (DEC), dipropyl carbonate (DPC), methylpropyl carbonate (MPC), ethylpropyl carbonte (EPC), ethylmethyl carbonate (EMC), ethylene carbonate (EC), propylene carbonate (PC), and butylene carbonate (BC).

12. The gel electrolyte composition of claim 1, wherein the gel electrolyte composition is crosslinked at a temperature ranging from 20° C. to 80° C.

13. A secondary battery comprising:
a positive electrode;
a negative electrode; and
the gel electrolyte composition according to claim lone of claim 1,
wherein the gel electrolyte composition includes a layer interposed between the positive electrode and the negative electrode.

14. The secondary battery of claim 13, wherein the secondary battery satisfies following Equation 1,
$${C}_{600} / {C}_{1 \geq } 0.8 , \qquad [ Equation 1 ]$$
and
in which in Equation 1,
C₆₀₀ is a discharge capacity of the secondary battery after charging and discharging operations are repeatedly performed at 600 times, and
C₁ is a discharge capacity of the secondary battery after the charging and discharging operations are performed one time.

15. The secondary battery of claim 13, wherein a positive electrode active material included in the positive electrode includes at least one selected from the group consisting of nickel, cobalt, manganese, tin, silicon and aluminum.

16. The secondary battery of claim 13, wherein a negative electrode active material included in the negative electrode includes at least one selected from the group consisting of graphite, silicon, germanium, tin, and antimony.

17. The secondary battery of claim 13, wherein the gel electrolyte composition is gelated on a surface of the negative electrode.
